(19) United States
(12) Patent Application Publication
(10) Pub. No.: US 2019/0082520 A1
(43) Pub. Date: Mar. 14, 2019

(54) WIDE ANGLE OPTICAL WIRELESS TRANSMITTER INCLUDING MULTIPLE NARROW BEAM WIDTH LIGHT EMITTING DIODES

(71) Applicants: Mohammad Noshad, Charlottesville, VA (US); Gaurav Patil, Charlottesville, VA (US); Xu Wang, Charlottesville, VA (US)

(72) Inventors: Mohammad Noshad, Charlottesville, VA (US); Gaurav Patil, Charlottesville, VA (US); Xu Wang, Charlottesville, VA (US)

(21) Appl. No.: 16/024,251

(22) Filed: Jun. 29, 2018

Related U.S. Application Data
(60) Provisional application No. 62/526,808, filed on Jun. 29, 2017.

(51) Int. Cl. H05B 37/02; H04B 10/2575; H04B 10/40

(52) U.S. Cl. CPC H05B 37/0272; H04B 10/40; H04B 10/25752

(57) ABSTRACT

Certain configurations of optical wireless communication devices that comprise a plurality of narrow beam width light emitting diodes to provide a wide-angle transmitter are described. The transmitter can be used, for example, in optical wireless communication systems. The transmitter can be designed to select one of the light emitting diodes that points towards the receiver for more reliable information exchange or data transmission. The particular light emitting diode used may change as a position of an end user changes.

### PRIORITY APPLICATION

This application claims priority to and the benefit of U.S. Provisional Application No. 62/526,808 filed on Jun. 29, 2017, the entire disclosure of which is hereby incorporated herein by reference for all purposes.

### TECHNOLOGICAL FIELD

Certain configurations described herein are directed to an optical wireless communication (OWC) device that comprises a plurality of narrow beam width light emitting diodes. The OWC device can be used, for example, in optical wireless communication systems in combination with one or more receivers.

### BACKGROUND

In visible light communication systems, signal coverage is limited by the beam angle of the light source and the distance between the target. When the target moves from one site to another, signal transmission can be interrupted.

### SUMMARY

Certain aspects described herein are directed to an optical wireless communication (OWC) device that can be present as part of an OWC system. In some examples, one or more OWC devices comprising a transmitter can be used to provide optical transfer of information from an area network, e.g., a wide area network, a local area network, etc., to the light fixture and to another OWC device, e.g., a network device, optical receiver, etc., coupled to an electronic device such as a computer, laptop, mobile device, television or other electronic devices. Information can be optically transferred from the electronic device back to the light fixture and on to the area network if desired. The exact light wavelength used may vary from visible light wavelengths (about 400 nm to about 800 nm) to infrared wavelengths (about 800 nm to about 3000 nm), and different light emitting diodes of the transmitter may comprise different light wavelengths if desired. In some configurations, the transmitter may be configured to select one of a plurality of light emitting diodes to provide an optical emission to a receiver optically coupled to the transmitter. The exact light emitting diode selected may change as the transmitter, receiver or both are moved from one position to another position. The use of a plurality of narrow beam width light emitting diodes together can provide a wide angle transmitter for more reliable optical communication between devices.

In a first aspect, an optical wireless communication device configured to provide optical communication with another optical wireless communication device comprises a processor, a receiver electrically coupled to the processor, and a transmitter electrically coupled to the processor, wherein the transmitter comprises a plurality of narrow beam width light emitting diodes each electrically coupled to the processor.

In another embodiment, the transmitter comprises at least three narrow beam width light emitting diodes each providing a beam cone, wherein the three narrow light beam light emitting diodes are positioned so a central axis of the beam cones diverge from each other. In other examples, the transmitter comprises at least three narrow beam width light emitting diodes each providing a beam cone, wherein the three narrow light beam light emitting diodes are positioned so a central axis of the beam cones converge toward each other. In further examples, the transmitter comprises at least three narrow beam width light emitting diodes each providing a beam cone, wherein the three narrow light beam light emitting diodes are positioned so the beam cones do not overlap in a first position of the optical wireless communication device relative to a position of the another optical wireless communication device. In some examples, the transmitter comprises three narrow beam width light emitting diodes each configured to provide an optical emission with a beam angle of 30 degrees or less. In additional examples, the transmitter further comprises at least one wide beam width light emitting diode configured to provide an optical emission with a beam angle of 60 degrees or more. In some examples, the transmitter comprises at least four narrow beam width light emitting diodes each configured to provide an optical emission with a beam angle of 30 degrees or less. In other embodiments, at least one of the plurality of narrow beam width light emitting diodes is configured as a laser diode. In other examples, each of the plurality of narrow beam width light emitting diodes is configured as a laser diode. In some examples, at least one of the plurality of narrow beam width light emitting diodes is configured as a laser diode and at least one of the plurality of narrow beam width light emitting diodes is configured as a junction diode. In certain examples, each of the plurality of narrow beam width light emitting diodes is configured to provide a light beam comprising a wavelength of 400 nm to about 800 nm or 800 nm to about 3000 nm.

In another aspect, an optical wireless communication system configured to provide and receive information from an area network to an electronic device is described. In some configurations, the optical wireless communication system comprises a first optical wireless communication device configured to couple to the area network, the first optical wireless communication device comprising a first transmitter and a first receiver each electrically coupled to a first processor, and a second optical wireless communication device configured to couple to the electronic device, wherein the second optical wireless communication device comprises a second transmitter and a second receiver each electrically coupled to a second processor, wherein the second transmitter comprises a plurality of narrow beam width light emitting diodes each electrically coupled to the second processor. In some instances, the optical wireless communication system is configured to select one of the plurality of narrow beam width light emitting diodes of the second optical wireless communication device to provide a first optical emission from the second transmitter to the first receiver based on a first position of the second optical wireless communication device relative to a position of the first optical wireless communication device and is configured to select a different one of the plurality of narrow beam width light emitting diodes of the second optical wireless communication device to provide a second optical emission from the second transmitter to the first receiver based on a second position of the second optical wireless communication device relative to the position of the first optical wireless communication device.

In certain examples, the electronic device coupled to the second optical wireless communication device is wirelessly coupled to the second optical wireless communication device. In other examples, the electronic device wirelessly coupled to the second optical wireless communication device comprises a wireless router. In certain embodiments, the electronic device coupled to the second optical wireless communication device is coupled through a wired device to the optical wireless communication device. In some examples, the electronic device coupled through the wired device comprises a USB interface, a micro-USB interface, a SATA interface, or a Lightning port interface.

In other examples, the first optical wireless communication device is configured as a light fixture and the area network is coupled to the light fixture wirelessly. In some examples, the light fixture is coupled to the area network in a wired manner. In other embodiments, the light fixture is coupled to the area network through a fiber optic cable. In certain embodiments, the light fixture is coupled to the area network through an Ethernet cable. In other embodiments, the light fixture is coupled to the area network through a power line.

In certain instances, the second transmitter of the second optical wireless communication device comprises at least three narrow beam width light emitting diodes each providing a beam cone, wherein the three narrow light beam light emitting diodes are positioned so a central axis of the beam cones diverge from each other.

In other instances, the second transmitter of the second optical wireless communication device comprises at least three narrow beam width light emitting diodes each providing a beam cone, wherein the three narrow light beam light emitting diodes are positioned so a central axis of the beam cones converge toward each other.

In some embodiments, the second transmitter of the second optical wireless communication device comprises at least three narrow beam width light emitting diodes each providing a beam cone, wherein the three narrow light beam light emitting diodes are positioned so the beam cones do not overlap in the first position of the second optical wireless communication device relative to the position of the first optical wireless communication device.

In other embodiments, the second transmitter of the second optical wireless communication device comprises at least three narrow beam width light emitting diodes each configured to provide an optical emission with a beam angle of 30 degrees or less. In certain examples, the second transmitter further comprises at least one wide beam width light emitting diode configured to provide an optical emission with a beam angle of 60 degrees or more.

In other configurations, the second transmitter of the second optical wireless communication device comprises at least four narrow beam width light emitting diodes each configured to provide an optical emission with a beam angle of 30 degrees or less.

In some examples, the first transmitter of the first optical communication device comprises a plurality of narrow beam width light emitting diodes each electrically coupled to the first processor. In some embodiments, the first transmitter of the first optical wireless communication device comprises at least three narrow beam width light emitting diodes each configured to provide an optical emission with a beam angle of 30 degrees or less. In some examples, the first transmitter further comprises at least one wide beam width light emitting diode configured to provide an optical emission with a beam angle of 60 degrees or more.

In certain examples, at least one of the plurality of light emitting diodes is configured as a laser diode.

In an additional aspect, an optical wireless communication system configured to provide and receive information from an area network to an electronic device comprises a first optical wireless communication configured to couple to the area network, the first optical wireless communication device comprising a first transmitter and a first receiver each electrically coupled to a first processor, wherein the first transmitter comprises a plurality of narrow beam width light emitting diodes each electrically coupled to the first processor, and a second optical wireless communication device configured to couple to the electronic device, wherein the second optical wireless communication device comprises a second transmitter and a second receiver each electrically coupled to a second processor. In some examples, the optical wireless communication system is configured to select one of the plurality of narrow beam width light emitting diodes of the first optical wireless communication device to provide a first optical emission from the first transmitter to the second receiver based on a first position of the second optical wireless communication device relative to a position of the first optical wireless communication device and is configured to select a different one of the plurality of narrow beam width light emitting diodes of the first optical wireless communication device to provide a second optical emission from the first transmitter to the second receiver based on a second position of the second optical wireless communication device relative to the position of the first optical wireless communication device.

In certain configurations, the electronic device coupled to the second optical wireless communication device is wirelessly coupled to the second optical wireless communication device. In other configurations, the electronic device wirelessly coupled to the second optical wireless communication device comprises a wireless router. In some examples, the electronic device coupled to the second optical wireless communication device is coupled through a wired device to the optical wireless communication device. In other examples, the electronic device coupled through the wired device comprises a USB interface, a micro-USB interface, a SATA interface, or a Lightning port interface.

In some examples, the first optical wireless communication device is configured as a light fixture and the area network is coupled to the light fixture wirelessly. In other examples, the light fixture is coupled to the area network in a wired manner. In some embodiments, the light fixture is coupled to the area network through a fiber optic cable. In certain examples, the light fixture is coupled to the area network through an Ethernet cable. In other examples, the light fixture is coupled to the area network through a power line.

In another aspect, a method of providing information, e.g., optical communication, between a first optical wireless communication device and a second optical wireless communication device is disclosed. In certain configurations, the method comprises using a first processor to select one of a plurality of narrow beam width light emitting diodes of a second transmitter of the second optical wireless communication device to provide an optical emission to a first transmitter of the first optical wireless communication device based on a first position of the second optical wireless communication device.

In some examples, the method comprises transmitting an information packet from each of the plurality of narrow beam width light emitting diodes to the first receiver to determine which of the plurality of narrow beam width light emitting diodes should be used to provide the optical emission.

In other examples, the method comprises configuring the first processor to determine which of the received information packets comprises the least amount of errors to generate a LED channel packet. The method may also comprise configuring the first processor to provide the generated LED channel packet to a second receiver of the second optical wireless communication device. The method may also comprise configuring a second processor of the second optical wireless communication device that is electrically coupled to the second receiver to use the received, generated LED channel packet to determine which of the plurality of narrow beam width light emitting diodes should be used to provide the optical emission.

In some configurations, the method comprises periodically transmitting the information packet over a first period from each of the plurality of narrow beam width light emitting diodes and using the first processor to determine which of the plurality of narrow beam width light emitting diodes should be used to provide the optical emission within the first period.

In other examples, the method comprises configuring the plurality of narrow beam width light emitting diodes to comprise at least three light emitting diodes.

In certain embodiments, the method comprises configuring the plurality of narrow beam width light emitting diodes to comprise at least four light emitting diodes.

In other examples, the method comprises configuring at least one of the plurality of narrow beam width light emitting diodes to be a laser diode.

In certain embodiments, the method comprises configuring the first optical wireless communication device as a light fixture in a building.

In other embodiments, the method comprises configuring the second optical wireless communication device with an interface to couple to an electronic device.

In certain examples, the method comprises configuring the interface to comprise a USB interface, a micro-USB interface, a SATA interface, or a Lightning port interface.

Additional aspects, configurations, embodiments, examples, illustrations and features are described in more detail below.

### BRIEF DESCRIPTION OF THE SEVERAL VIEWS OF THE DRAWINGS

Certain specific illustration of optical wireless communication systems are described below with reference to the accompanying figures in which:

FIG. 1A is an illustration of an optical wireless communication system within a structure, in accordance with certain examples;

FIG. 1B is an illustration of an optical wireless communication system coupled to an area network though a wireless connection, in accordance with certain examples;

FIG. 1C is an illustration of an optical wireless communication system coupled to an area network though a wired connection, in accordance with certain examples;

FIG. 1D is an illustration of an optical wireless communication system coupled to an area network though a power line, in accordance with certain examples;

FIG. 2 is an illustration of a transmitter comprising a plurality of light emitting diodes, in accordance with some examples;

FIG. 3 is an illustration of an optical wireless communication system comprising two optical wireless communication (OWCs) devices, in accordance with some embodiments;

FIG. 4A is an illustration showing two OWCs in a first position and FIG. 4B is an illustration showing movement of one of the OWCs to a second position, in accordance with some examples;

FIG. 5 is an illustration showing positioning of light emitting diodes so the beam cones overlap to at least some extent, in accordance with certain examples;

FIG. 6 is an illustration showing positioning of light emitting diodes so a central axis of the beam cones converge, in accordance with certain examples;

FIG. 7 is an illustration showing positioning of light emitting diodes so a central axis of the beam cones diverge, in accordance with certain embodiments;

FIG. 8 is an illustration showing packets that can be used to determine which particular light emitting diode should be used to provide an optical emission, in accordance with certain embodiments;

FIG. 9 is a flow chart showing a sequence of events that can take place in an OWC device comprising a plurality of light emitting diodes, in accordance with certain embodiments;

FIG. 10 is a flow chart showing a sequence of events that can take place in an OWC device that is optically coupled to another OWC device comprising a plurality of light emitting diodes, in accordance with certain embodiments;

FIG. 11 is an illustration showing a system comprising two OWC devices optically coupled to each other where one of the OWC devices comprises a plurality of light emitting diodes, in accordance with certain examples;

FIG. 12 is another illustration showing a system comprising two OWC devices optically coupled to each other where one of the OWC devices comprises a plurality of light emitting diodes, in accordance with certain examples; and

FIG. 13 is another illustration showing a system comprising two OWC devices optically coupled to each other where both of the OWC devices comprise a plurality of light emitting diodes, in accordance with certain examples.

It will be recognized by the person of ordinary skill in the art that the illustrations shown in the figures are not intended to limit the number, orientation, angle or the like of the various light emitting diodes. Block diagrams are used to provide a more user-friendly description of various configurations and are not intended to imply or suggest that any one configuration is required or needed for the system to properly function.

### DETAILED DESCRIPTION

Certain illustrative configurations described herein are directed to a transmitter that can be used in an OWC system to reliably send and/or receive information to a remote receiver not physically coupled to the transmitter. For example, the transmitter may be configured to provide reliable optical communication between the transmitter and the remote receiver even when the remote receiver is moving or has been moved or even when the transmitter is moving or has been moved. As noted in more detail below, the transmitter may also comprise its own receiver configured to receive optical emissions from a transmitter of the remote receiver. By using a plurality of narrow beam width light emitting diodes in place of a wide beam width light emitting diode, the power used by the device can be reduced by 1/N where N is the number of narrow beam width light emitting diodes present in the device.

As used herein the term “light emitting diode” is intended to include both conventional light emitting diodes, super luminescent diodes and laser diodes as a subset of light emitting diodes. While not wishing to be bound by any one configuration, a light emitting diode can be configured as a junction diode comprising a semiconductor material, e.g., GaAsP. Laser diodes may also comprise a semiconductor material similar to those used in LEDs, however laser diodes tend to emit light in a more narrow or converging beam, e.g., emitting a more spatially coherent beam, compared to the beam emitted in conventional light emitting diodes, e.g., the conventional LED provides a more diverging beam than the beam provided by a laser diode. Where multiple diodes are present in the transmitters described herein, the use of a plurality of laser diodes can provide for better spatial separation of the various light beams provided by the transmitter. This configuration can increase the number of separate light channels that can be provided in a selected amount of space on the transmitter. The various diodes used herein can be operated in a continuous manner or can be chopped or pulsed as desired.

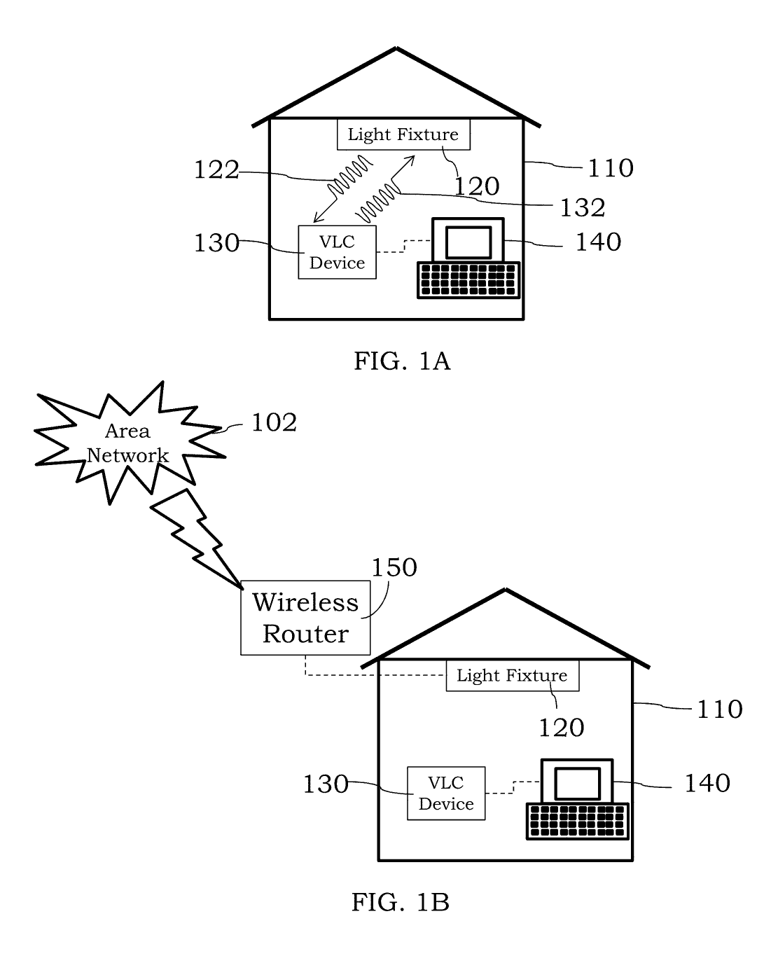

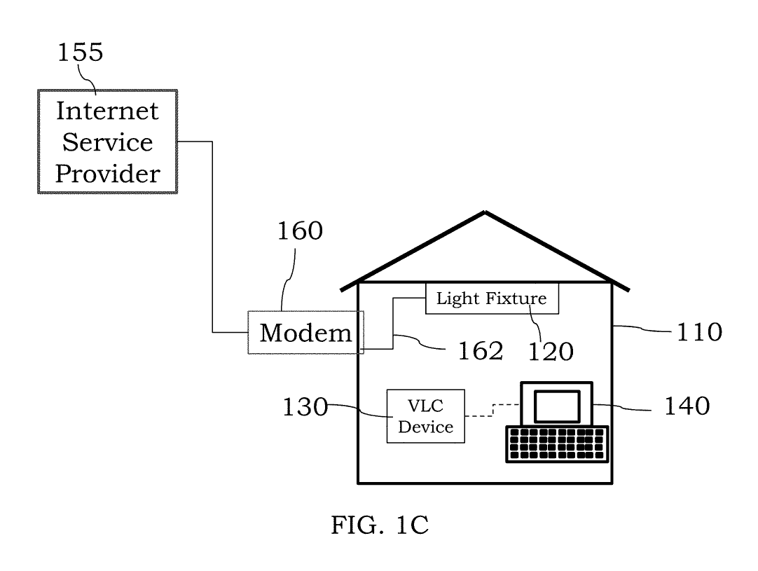

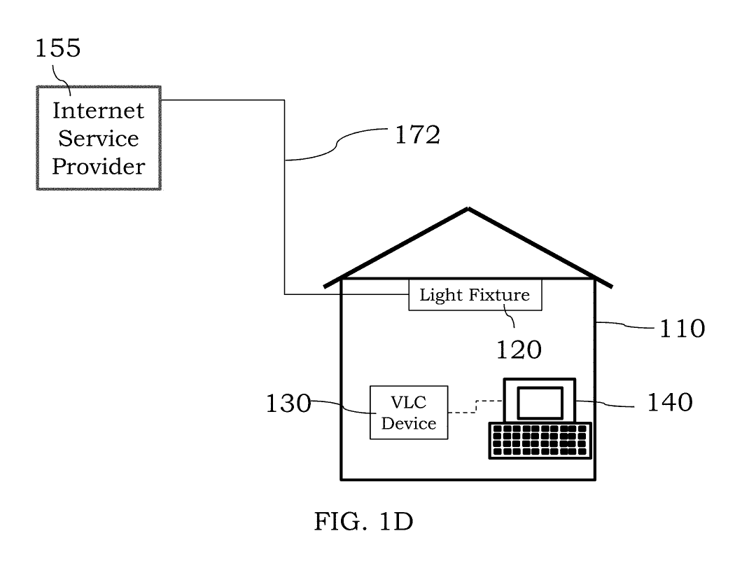

In certain embodiments, the systems described herein can be used to provide optical communication to one or more users. For example and referring to FIG. 1A, an optical wireless communication system within a structure 110 may comprise a light fixture 120 that is optically coupled to an OWC device 130, e.g., a transmitter/receiver as described herein, electrically coupled to a computer 130 or other electronic device. The light fixture 120 is electrically coupled or optically coupled or both to a wide area network (WAN), local area network (LAN), etc. to receive and send information or signals to and from the area network. The area network can provide information to the light fixture 120 which can, if desired, encode/modulate the information and emit light in the form of an optical emission 122 comprising the information. The OWC device 130 (labeled as VLC device in FIGS. 1A-1D) can receive the optical emission 122, decode the received information (when the received information is encoded) and provide it to the computer 140 or other electronic device coupled to the OWC device 130. The computer 140 may request information from the area network and can emit light as an optical emission 132, e.g., the optical emission 132 may comprise encoded/modulated information that is received by the light fixture 120. The light fixture 120 may then decode the information received from the OWC device 130 and send a request to the area network to retrieve and send the information back to the light fixture 120. This process can be repeated to provide network communication between the area network and the computer 140 using optical wireless communication.

In certain examples, while the exact light wavelength may vary, typical visible light wavelengths used are in the 400-800 nm range and typical infrared light wavelengths range from 800 nm to 3000 nm. As noted in more detail below, the light fixture 120, the VLC device 130 or both may comprise a plurality of light emitting diodes (LEDs) each of which is configured to provide independent light emissions. The light fixture 120 may also comprise an optical receiver to receive optical emissions from the OWC device 130. Similarly, the OWC device 130 may comprise an optical receiver and/or optical transmitter to be able to receive and send optical signals to the light fixture 120. The OWC device 130 can wirelessly couple to the computer 140 (or another electronic device) or may couple to the computer 140 (or another electronic device) in a wired manner, e.g., through a wire between the OWC device 130 and a USB interface, a micro-USB interface, a SATA interface, or a Lightning port interface.

As shown in FIGS. 1B-1D, the light fixture 120 can couple to an area network 102 such as a wide area network in numerous manners or an internet service provider 155. Referring to FIG. 1B, wireless coupling between the light fixture 120 and a remote wireless router 150 mounted to a utility pole 155 is shown. The remote wireless router 150 can be coupled to a wide area network 102 by way or wired or wireless means. In another configuration as shown in FIG. 1C, a modem 160 can couple to the light fixture 120 through a wired connection 162. Illustrative modems include, but are not limited to, cable modems, DSL modems, dial up modems, etc. The wired connection 162 can be by way of RG-6 cable, Ethernet cable or other wired cables including both electrical and fiber optic cables. In an additional configuration, the light fixture 120 can couple to the area network directly through a power line 172 as shown in FIG. 1D. The light fixture 120 comprises its own processor and an optical transmitter/receiver to be able to send and receive optical emissions to and from the OWC device 130. The OWC device 130 typically comprises its own processor and an optical receiver/transmitter to receive optical emissions from the light fixture 120 and to send optical emissions to the light fixture 120.

In certain embodiments, the connection between the OWC device 130 and the computer 140 (or other electronic device) may be by way of a wired connection or a wireless connection. For example, the OWC device 130 may comprise a Bluetooth device, a radio transmitter, a cellular chip, etc. that can send signals or information from the OWC device to the computer 140. In some instances, optical communication between the OWC device 130 and the computer 140 can be used to transfer information. Other means of information transfer between the OWC device 130 and the computer 140 can also be used.

In certain examples, the light fixture 120 can encode/modulate signals received from the area network using a desired modulation such as, for example, Hadamard coded modulation as described in U.S. Ser. No. 15/914,749 filed on Mar. 7, 2018. The encoded and modulated signals can be sent to a single user or can be used in multi-user systems. The OWC device 130 can decode the encoded and modulated signals and provide them to an electronic device electrically coupled to the OWC device 130. The electronic device can then request information from the area network, and the OWC device 130 can encode/modulate the signals and send the encoded/modulated signal back to the light fixture 120 by way of an optical emission from the OWC device 130. The encoded and modulation can be selected such that the optical emissions are flicker free or substantially flicker free to provide more aesthetic and visually appealing light emissions from a light fixture, e.g., one comprises one or more light emitting diodes. In some examples, each of the plurality of LED's of the transmitter can be configured to provide encoded optical emissions, whereas in other instances less than all of the LED's of the transmitter can be configured to provide encoded optical emissions.

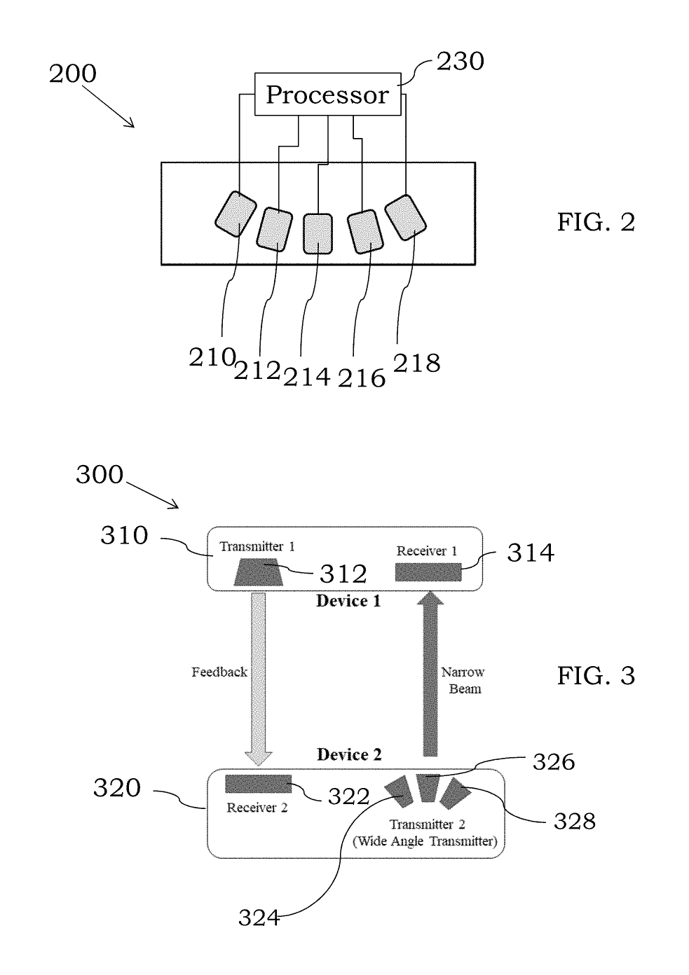

In certain embodiments, a transmitter 200 may comprise a plurality of individual and independent light emitting diodes 210-218 as shown in FIG. 2. While the illustration shown in FIG. 2 comprises five light emitting diodes 210-218, fewer or more than five LED's can be present. In some instances, two, three, four, five, fix, seven, eight, nine, ten or more than ten individual LEDs may be present in the transmitter 200. As noted herein, each of the LEDs 210-218 can be configured as a junction diode, a laser diode or other light emitting diodes. The transmitter 200 of the OWC device typically also comprises a processor 230 electrically coupled to each of the LEDs 210-218. The processor 230 may comprise executable instructions to permit selection of one or more of the LED's 210-218 for optical transmission to an optically coupled receiver (not shown). To increase the overall “width” of the transmitter 200 additional LEDs may be present in the transmitter 200 to provide additional independent light channels.

In some embodiments, one, two or more of the LEDs of the transmitter can be configured as narrow beam width LEDs (NBWLEDs). Reference herein to NBWLEDs refers to LED's whose beam angle is 30 degrees or less. In other instances, each of the LEDs present in the transmitter can be configured as NBWLEDs. In some examples, the transmitter may be configured as a hybrid system and comprise one or more NBWLEDs and one or more wide beam width LEDs (WBWLEDs). Reference herein to WBWLEDs refers to LED's whose beam angle is 60 degrees or greater. If desired, the devices and systems may also comprise one or more light emitting diodes with a beam angle between 30 degrees and 60 degrees. While not necessarily the same in all cases, the beam angle can be measured at a distance from a first optical communication device to a second optical communication device. Where the OWCs are present in a commercial building, the distance between the OWC devices may be, for example, 5 feet to about 15 feet, more particularly about 6 feet to about 12 feet or about 6 feet to about 8 feet, though this distance can change as one or more of the OWC devices are moved. If desired, a beam radius can be determined using the beam angle and a particular distance between the OWC devices. In some configurations, the beam radius can be selected so there is little or no overlap between the light beams of the various light emitting diodes at a typical distance used between the OWC devices. The lack of beam overlap can provide for a plurality of independent light channels that can be used to determine which particular light channel may be best for optical communication between the OWC devices.

In certain configurations and as noted in more detail below, the OWC device can be configured to select the best LED that points towards a receiver for data transmission. This LED selection is based on the response that the other receiver receives from the first transmitter. For example and referring to FIG. 3, an OWC system 300 comprises a first OWC device 310 that is optically coupled to a second OWC device 320. While not shown, each of the OWC devices 310, 320 typically comprises its own respective processor that is electrically coupled to the transmitter and receiver of that particular OWC device. The first OWC device 310 may be a light fixture, and the second OWC device 320 may be a visible light communication (VLC) device as noted herein that is coupled to a computer, tablet, etc. The OWC device 310 comprises a transmitter 312 and a receiver 314. The OWC device 320 comprises a receiver 322 and a transmitter comprising a plurality of narrow beam width LEDs 324, 326, and 328. The receiver 322 is optically coupled to the transmitter 312 to receive optical emissions from the transmitter 312. The receiver 314 can be optically coupled to any one or more of the LEDs 324, 326, 328 to receive optical emissions from the LEDs 324, 326, 328. In operation, the response received by the receiver 314 can be used to determine which one or more of the LEDs 324, 326, 328 should provide the optical emission to the receiver 314.

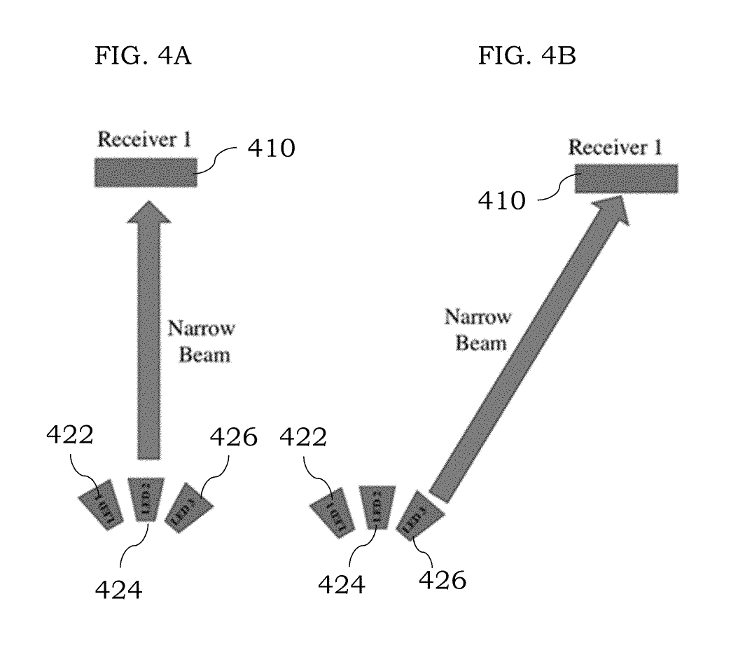

In some instances, as the position of the OWC device 320 is moved relative to the position of the OWC device 310, the exact angle between the devices 310, 320 can change. When this angle change occurs, proper optical transmission between the OWC devices 310, 320 may be interrupted. An illustration of this result is shown in FIGS. 4A and 4B. The LEDs 422, 424 and 426 can be part of a transmitter of an OWC device. In FIG. 4A, the angle between the receiver 410 and the LED 424 is about 0 degrees. LED 424 can be selected from all of the LEDs 422, 424 and 426 to provide an optical emission to the receiver 410 that is used by the receiver 410 for optical communication. As the position of the OWC device is changed (as shown in FIG. 4B), it may be desirable to use LED 426 to provide an optical emission to the receiver 410 to provide better optical communication between the receiver 410 and the OWC device comprising the LEDs 422, 424 and 426. Depending on the exact angle, however, the particular LED used may change from time to time as the angle between the OWC devices changes. This change permits dynamic adjustment of the system to reduce or avoid communication disruptions. In addition to providing more reliable communication, by using a plurality of NBWLEDs, reduced power consumption can be achieved which is particularly important where a tablet, laptop, etc. is being used to power the OWC device. In comparison, WBWLEDs tend to use much more power than the NBWLEDs.

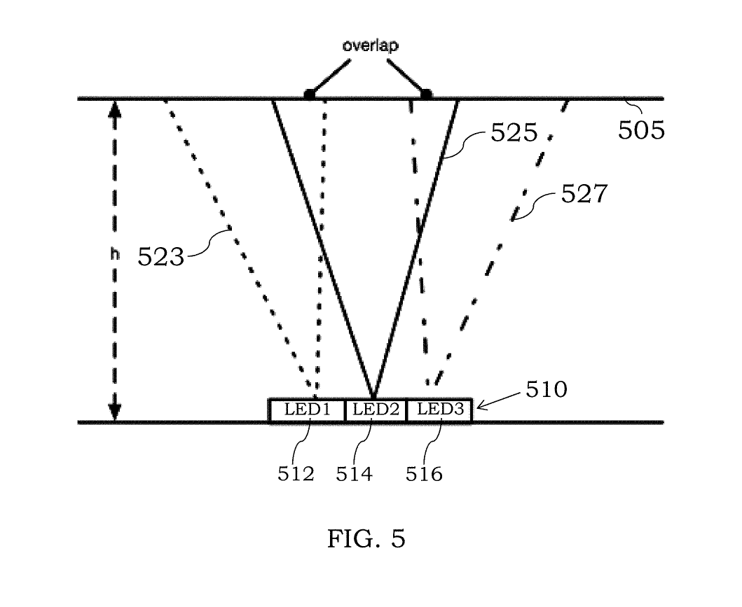

In certain configurations, the exact positioning of one NBWLED compared to another NBWLED may vary. An illustrative configuration is shown in FIG. 5. The outer LEDs (512 and 516) are tilted away from each other, and the central LED (514) is generally positioned to provide a beam with a central axis that is orthogonal to the transmitter housing 510. For example, the LED 512 provides a beam cone 523 with a central axis, the LED 514 provides a beam cone 525 with a central axis, and the LED 516 provides a beam cone 527 with a central axis. A bottom surface 505 of a receiver is shown for discussion purposes and to demonstrate the beam angle/pattern of the different LEDs when the receiver is positioned a distance “h” from the transmitter comprising the LEDs 512, 514, 516. As can be seen in FIG. 5, there is overlap between the various beam cones 523, 525, 527 at some portions of the surface 505, and there is no overlap of the beam cones 523, 525, 527 at other portions of the surface 505. The central axis of the beam cone 523 generally diverges from a central axis of the beam cone 525. Similarly, a central axis of the beam cone 527 diverges from both of the central axes of the beam cones 523, 525. The exact angle between the various central axes may vary as desired. The exact tilting of the LEDs 512, 514 and 516 may be varied depending on how much beam overlap is desired. While three NBWLEDs are shown in FIG. 5 for illustration purposes, two, four, five or more NBWLEDs could instead be present if desired.

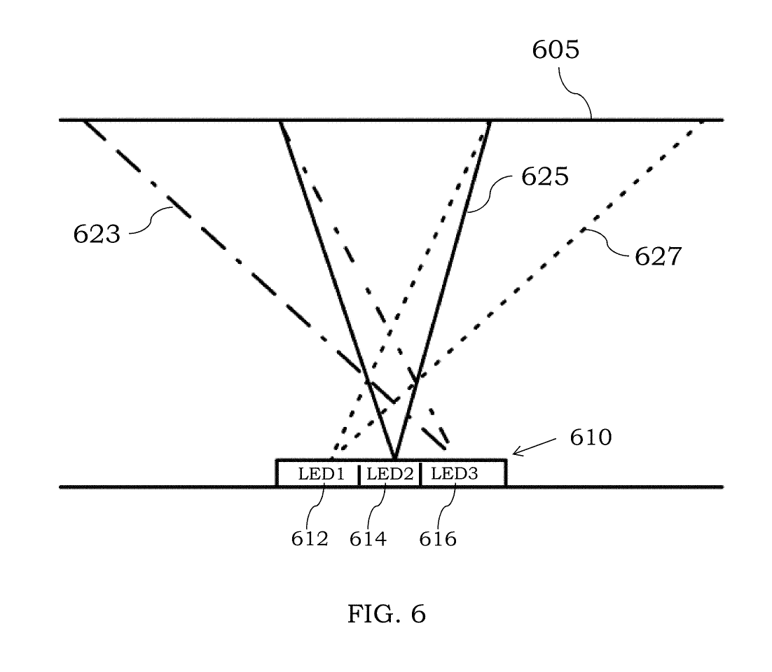

In certain embodiments, another configuration of LED positioning is shown in FIG. 6 where three LEDs 612, 614 and 616 are shown as being present in a transmitter 610 of an OWC device. LEDs 612 and 616 are tilted toward each other so there is greater overlap in the beam cones 623, 625 and 627 near a surface of the transmitter 610 as compared to that shown in FIG. 5. In the configuration of FIG. 6, the LED 616 can provide optical communication toward the left of the transmitter 610 and the LED 612 can provide optical communication toward the right of the transmitter 610. For example, as the beam approaches a surface 605, depending on the position of a receiver (not shown) along the surface 605, a different LED from the LEDs 612, 614 and 616 can be selected to provide optical communication between the transmitter 610 and a receiver. While three NBWLEDs are shown in FIG. 6 for illustration purposes, two, four, five or more NBWLEDs could instead be present if desired. Each of the LEDs 612, 614, 616 provides a beam cone 627, 625 and 623, respectively. In this configuration, a central axis of the beam cone 627 converges and crosses a central axis of the beam cone 625 and a central axis of the beam cone 623. Similarly, a central axis of the beam cone 623 converges and crosses the central axis of the beam cone 625 and the beam cone 627.

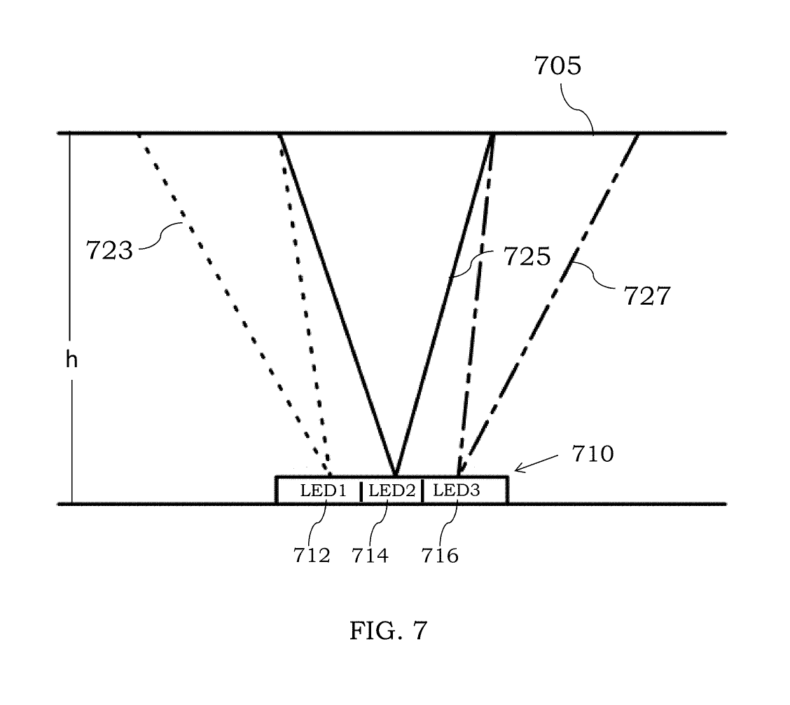

In another example, an additional configuration of LED positioning is shown in FIG. 7. In this configuration, the LEDs 712, 714 and 716 are configured so there is little or no overlap in the beam cones 723, 725 and 727 at a distance “h” between a surface 705 of a receiver and the transmitter 710. The central axis of each of the beams ones 723, 725 and 727 generally diverge from one another. The exact angle between the various central axes may vary as desired. The lack of beam cone overlap at the distance “h” permits selection of only one of the LEDs 723, 725, 727 (depending on the position of the receiver) for optical communication between the transmitter 710 and the receiver. While three NBWLEDs are shown in FIG. 7 for illustration purposes, two, four, five or more NBWLEDs could instead be present if desired.

While FIGS. 5-7 show various LED configurations for illustrative purposes, additional optical elements such as lenses, filters and other optical elements can be present between the LEDs of the transmitter and the receiver to alter the beam shape, width, wavelength, etc. as desired.

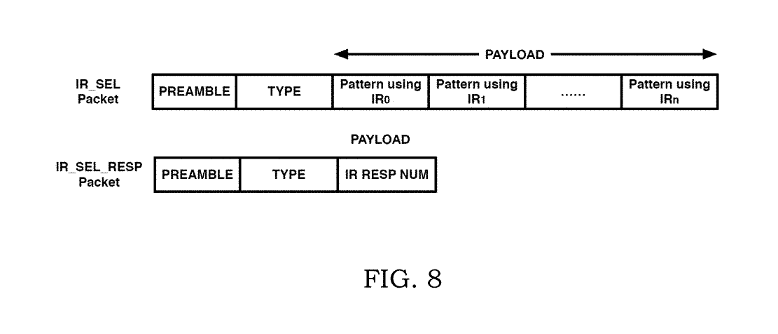

In certain examples, to select one or more LEDs for optical communication between a transmitter and a receiver, the OWC system can be configured to scan to determine which particular LED may be selected. A block illustration is shown in FIG. 8 to illustrate one of the possible methodologies that can be implemented. In this illustration, Transmitter 2 refers to the transmitter of Device 2 that comprises two or more NBWLEDs and Receiver 2, and Device 1 refers to the OWC device that comprises a transmitter (Transmitter 1) and a receiver (Receiver 1). In order to choose the right direction for Transmitter 2, Device 1 can be configured to provide a fixed pattern from Transmitter 1 in multiple directions and wait for a response from Device 2 to determine which direction provides the best performance, e.g. by measuring signal intensity, response time, packet errors, pattern errors or other parameters. In one configuration, two packet types can be provided, IR_SEL and IR_SEL_RESP. IR_SEL is scheduled to be sent from Device 2 to the Device 1 in a periodic manner. This configuration is based on the consideration that the need for switching the direction is due to change in the position of Device 1 or Device 2 which is assumed to have a limited movement speed. In case of poor connection between Transmitter 1 and Receiver 2, Transmitter 2 can switch between multiple directions to send the IR_SEL preamble and type fields. Device 2 can be configured to continue to send IR_SEL until receiving IR_SEL_RESP from Device 1. In case of a poor connection between Transmitter 1 and Receiver 2, even if Device 1 receives the IR_SEL successfully, the IR_SEL_RESP generally is not recovered by Device 2. Then Device 2 will follow the same mechanism as if the feedback path is poor. Both the IR_SEL and IR_SEL_RESP can be provided with a data stream, e.g., data packets, and therefore not affect the normal transmission of data.

Referring more particularly to FIG. 8, TYPE is the type of the packet, and it can be used to represent Data or IR_SEL/IR_SEL_RESP. Both IR_SEL and IR_SEL_RESP can share the same type value since they are only sent in a fixed direction. The values chosen for Data and IR_SEL/IR_SEL_RESP may have a large hamming distance to simplify the identification in case of bit errors. For illustration purposes only, examples of the chosen values include IR_SEL/IR_SEL_RESP: 0x7777, and DATA: 0x8888. IR_SEL is the request sent from Device 2 to Device 1. In this packet, the PREAMBLE and TYPE can be sent using IR_PREV, which is the direction that has been used to send data. The Payload includes the same repetitive pattern sent in multiple directions sequentially and indexed in order. One example of test pattern is 0xCA16CA16 0xCA16CA16 0xCA16CA16 0xCA16CA16. If desired, the pattern used can be changed to better test channel conditions. IR_SEL_RESP is the response from Device 1 to Device 2. After Device 1 receives the IR_SEL Packet, it can check the payload sequentially to determine which of the patterns (sent using different directions) has the least amount of errors. Device 1 and Device 2 agree on the predetermined test pattern. Device 1 then sends the identification number of the direction that corresponds to the pattern with least errors in the IR RESP NUM field of the IR_SEL_RESP packet. Tr refers to the Timeout timer for Device 2 before sending a new IR_SEL while no IR_SEL_RESP is received. Ti refers to the Timeout timer for Device 2 before sending a new IR_SEL after receiving a IR_SEL_RESP.

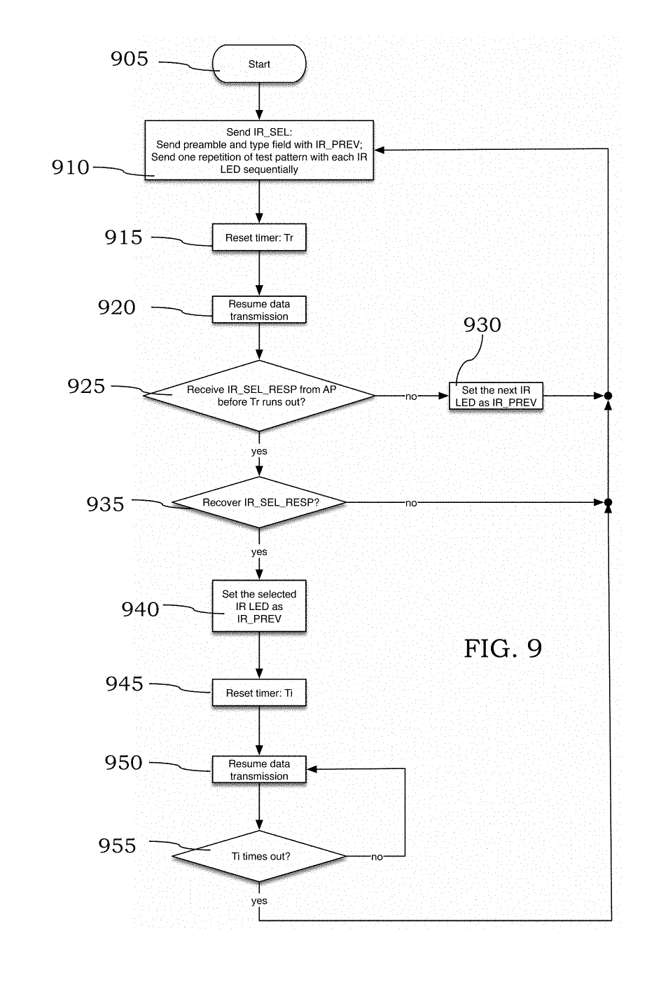

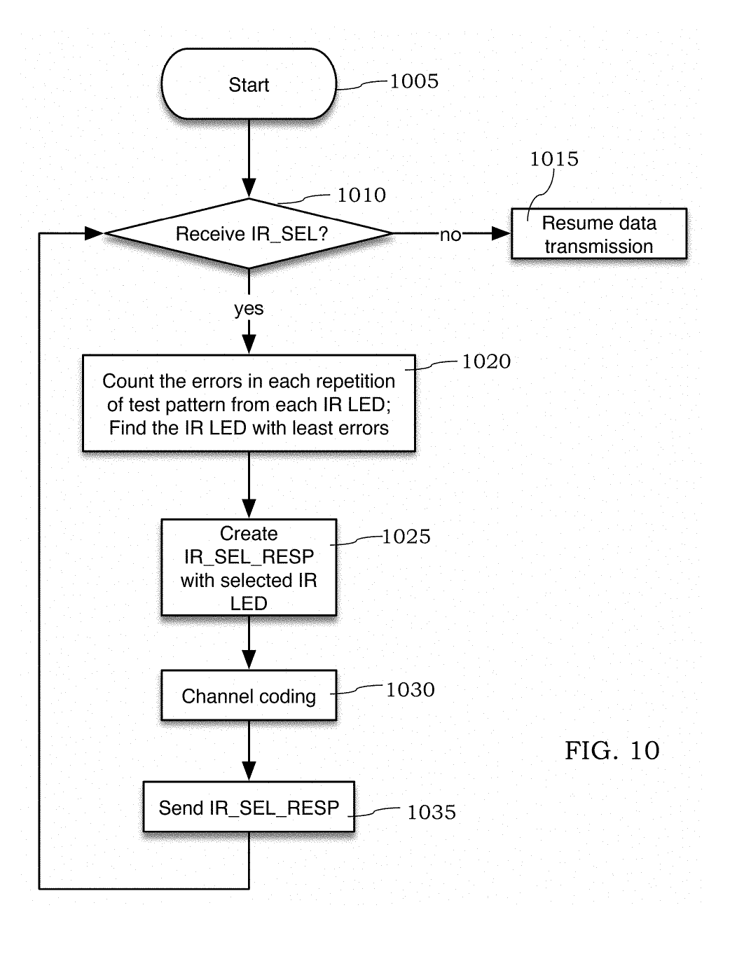

In certain embodiments, FIGS. 9 and 10 show illustrations of the sequence of events that Device 2 and Device 1 can implement. Referring to FIG. 9, Device 2 (the device comprising the plurality of NBWLEDs) starts from a reset state at a step 905. Device 2 then transmits an IR_SEL Packet at a step 910 where the PREAMBLE and TYPE is sent using IR_PREV while the Payload includes the same repetitive pattern sent using each of the directions sequentially. After sending the IR_SEL packet, Device 2 transmits DATA packets/frames (if any) and waits at a step 915 for a response from Device 1 for at most Tr before retransmitting IR_SEL packet at step 920. If Device 2 does not receive a response before timeout Tr at a step 925, implying the possibility that Device 1 did not receive the preamble of the IR_SEL properly, Device 2 then changes the direction for the preamble transmission (IR_PREV) and retransmits the IR_SEL packet at a step 930. This process can be performed every time Device 2 does not receive a response from Device 1 within Tr. However, if Device 2 does receive a response at the step 925, it then checks and corrects errors in the payload using error correction of the channel coding. If more errors are found than can be corrected (indicating a poor downlink channel condition) or the LED number received is greater than the total number of directions on Device 2 due to more errors at a step 935, the IR_SEL packet is immediately resent using the same IR_PREV. If no errors are found, then DEVICE 2 resets timeout Ti and saves the corrected response (IR_RESP_NUM field) from Device 1 into IR_PREV at a step 940. Starting next frame Device 2 uses this updated IR_PREV. The timer Ti is reset at a step 945, and the Device 2 transmits DATA packets/frames at a step 950. If the timer Ti is timed out at a step 955, the IR_SEL packet is sent again after the current DATA frame/packet transmission and this entire procedure is repeated. If Device 2 does not get a response from Device 1 even after it has tried all of the directions for preamble, meaning that Device 2 is probably far away from Device 1, Device 2 can optionally increase the Timeout Tr so it can transmit the IR_SEL packet less frequently and disable data transmission to save power until the next IR_RESP packet is received from Device 1.

Referring to FIG. 10, an illustration of the sequence of events that can be implemented by Device 1 (the receiver designed to receive an optical emission from one or more of the NBWLEDs of the transmitter) is shown. From a start or initial step 1005, when Device 2 transmits the pattern sequentially using different IRs placed at different angles with horizontal, Device 1 receives some of those patterns better than the others. If Device 1 can detect the preamble sent using this IR_PREV LED, it receives this IR_SEL packet at a step 1010, it can count the errors in each repetition of the test pattern from each LED to find the LED with the least errors at a step 1020. Device 1 can then create an IR_SEL_RESP at a step 1025 and respond at steps 1030, 1035 with an IR_SEL_RESP packet, e.g., can provide a LED channel packet that includes information about which particular LED provided the best response. For example, this response packet has the identification number for the direction of the Transmitter 2 in the IR_RESP_NUM field which represents the Pattern received having the least amount of errors. Although, if Device 1 does not receive the preamble correctly, it does not receive the packet and does not respond but can continue to transmit data at a step 1015 to establish communication with Device 2. Device 1 does not need any information of how many directions Device 2 can have, if, there is an agreement on the maximum number of directions that a Device 2 can support, which, also governs the size of the IR_SEL packet.

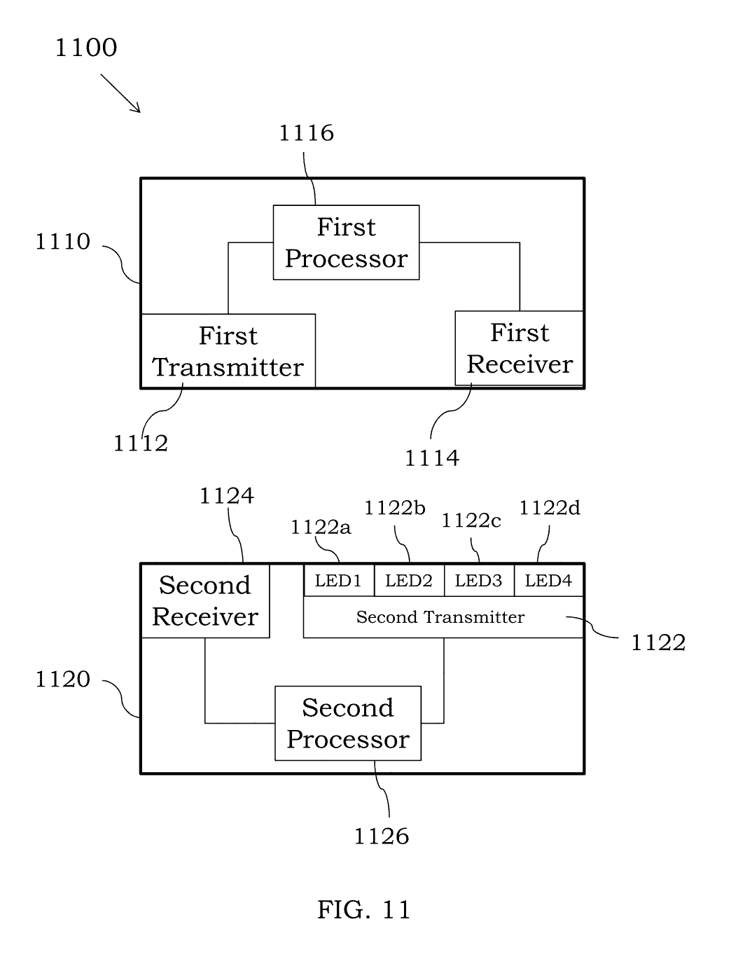

In certain examples and referring to FIG. 11, an OWC system 1100 is shown that comprises a first OWC device 1110 comprising a first transmitter 1112 and a first receiver 1114. A first processor 1116 is shown as being electrically coupled to each of the first transmitter 1112 and the first receiver 1114. The first OWC device 1110 can be coupled, e.g., in a wired or wireless manner, to an area network (not shown). For example, the first OWC device 1110 can be configured as a light fixture present within a building or other structure. The area network can be coupled to the light fixture in a wired manner, wireless manner, through a fiber optic cable, Ethernet cable, power line or other means. The system 1100 also comprises a second OWC device 1120 comprising a second transmitter 1122 and a second receiver 1124. The second transmitter 1122 and the second receiver 1124 are each electrically coupled to a second processor 1126. The second transmitter 1122 comprises a plurality of narrow beam width light emitting diodes 1122a, 1122b, 1122c and 1122d, though fewer than four or more than four narrow beam width light emitting diodes may be present if desired. The diodes 1122a-1122d may be the same or may be different. Each of the LEDs 1122a-1122d can be electrically coupled to the processor 1126 such that the processor 1126 can control which particular LED or LEDs provide an optical emission to the first receiver 1114 to permit optical communication between the OWC device 1110 and the OWC device 1120. While not shown, the OWC device 1120 is typically coupled, e.g., in a wired or wireless manner, to an electronic device such as a wired router, a wireless router, a computer, a tablet, a mobile device or other electronic device. The OWC device 1120 can be coupled optically to an electronic device, e.g., through a fiber optic cable, as well if desired. Where the OWC device 1120 is coupled to an electronic device in a wired manner, the electronic device can couple to the OWC device 1120 through a USB interface, a micro-USB interface, a SATA interface, Ethernet interface, a Lightning port interface or other interfaces. Where the OWC device 1120 is coupled to an electronic device in a wireless manner, the electronic device can couple to the OWC device 1120 using Bluetooth, Wi-Fi, near field communication or other wireless communication protocols.

In certain examples and as described herein, as a position of the OWC device 1120 is moved from a first position to a second position (different than the first position), the processors 1116 and 1126 can together be used to determine which particular LED of the LEDs 1122a-1122d should be used to provide an optical emission from the second OWC device 1120 to the first OWC device 1110. Where multiple independent optical emissions are occurring from the LEDs 1122a-1122d, the system can be configured to select which optical emission provides reliable optical communication between the devices 1110, 1120. For example, the OWC system 1100 can be configured to select one of the plurality of narrow beam width light emitting diodes 1122a-1122d of the second OWC device 1120 to provide a first optical emission from the second transmitter 1122 to the first receiver 1114 based on a first position of the second OWC device 1120 relative to a position of the first OWC device 1110. The OWC system 1100 can also be configured to select a different one of the plurality of narrow beam width light emitting diodes 1122a-1122d of the second OWC device to provide a second optical emission from the second transmitter 1122 to the first receiver 1114 based on a second position of the second OWC device 1120 relative to the position of the first OWC device 1110. As the position of the second OWC device 1120 changes, e.g., as a user moves about a room, the processors 1116 and 1126 can together determine which particular LED provides the best signal between the second OWC device 1120 and the first OWC device 1110. While not required, the first OWC device 1110 generally remains stationary within a building or other structure so the position of the first transmitter 1112 and first receiver 1114 generally do not change relative to the building or other structure.

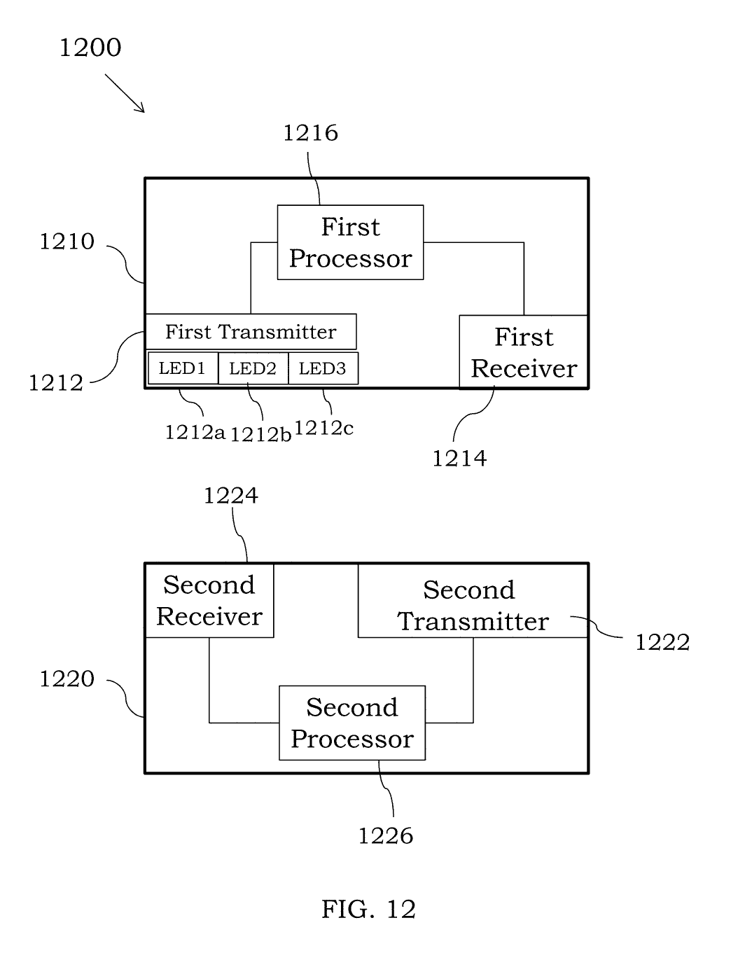

In another configuration and referring to FIG. 12, the first OWC device could instead comprise a plurality of light emitting diodes. For example, an OWC system 1200 is shown that comprises a first OWC device 1210 comprising a first transmitter 1212 and a first receiver 1214. A first processor 1216 is shown as being electrically coupled to each of the first transmitter 1212 and the first receiver 1214. The first OWC device 1210 can be coupled, e.g., in a wired or wireless manner, to an area network (not shown). For example, the first OWC device 1210 can be configured as a light fixture present within a building or other structure. The area network can be coupled to the light fixture in a wired manner, wireless manner, through a fiber optic cable, Ethernet cable, power line or other means. The first transmitter 1212 comprises a plurality of narrow beam width light emitting diodes 1212a, 1212b, and 1212c though fewer than three or more than three narrow beam width light emitting diodes may be present if desired. Each of the LEDs 1212a-1212c may be the same or may be different. Each of the LEDs 1212a-1212c can be electrically coupled to the processor 1216 such that the processor 1216 can control which particular LED or LEDs provide an optical emission to a second receiver 1224 of a second OWC device 1220 to permit optical communication between the OWC device 1210 and the OWC device 1220. The second OWC device 1220 also comprises a second transmitter 1222. The second transmitter 1222 and the second receiver 1224 are each electrically coupled to a second processor 1226. While not shown, the OWC device 1220 is typically coupled, e.g., in a wired or wireless manner, to an electronic device such as a wired router, a wireless router, a computer, a tablet, a mobile device or other electronic device. The OWC device 1220 can be coupled optically to an electronic device, e.g., through a fiber optic cable, as well if desired. Where the OWC device 1220 is coupled to an electronic device in a wired manner, the electronic device can couple to the OWC device 1220 through a USB interface, a micro-USB interface, a SATA interface, Ethernet interface, a Lightning port interface or other interfaces. Where the OWC device 1220 is coupled to an electronic device in a wireless manner, the electronic device can couple to the OWC device 1220 using Bluetooth, Wi-Fi, near field communication or other wireless communication protocols.

In certain configurations and as described herein, as a position of the OWC device 1220 is moved from a first position to a second position (different than the first position), the processors 1216 and 1226 can together be used to determine which particular LED of the LEDs 1212a-1212c should be used to provide an optical emission from the first OWC device 1210 to the second OWC device 1220. For example, the OWC system 1200 can be configured to select one of the plurality of narrow beam width light emitting diodes 1212a-1212c of the first OWC device 1210 to provide a first optical emission from the first transmitter 1212 to the second receiver 1224 based on a first position of the second OWC device 1220 relative to a position of the first OWC device 1210. Where multiple independent optical emissions are occurring from the LEDs 1212a-1212c, the system can be configured to select which optical emission provides reliable optical communication between the devices 1210, 1220. The OWC system 1200 can also be configured to select a different one of the plurality of narrow beam width light emitting diodes 1212a-1212c of the first OWC device 1210 to provide a second optical emission from the first transmitter 1212 to the second receiver 1224 based on a second position of the second OWC device 1220 relative to the position of the first OWC device 1210. As the position of the second OWC device 1220 changes, e.g., as a user moves about a room, the processors 1216 and 1226 can together determine which particular LED provides the best signal (or a reliable signal) between the second OWC device 1220 and the first OWC device 1210. While not required, the first OWC device 1210 generally remains stationary within a building or other structure so the position of the first transmitter 1212 and first receiver 1214 generally do not change relative to the building or other structure.

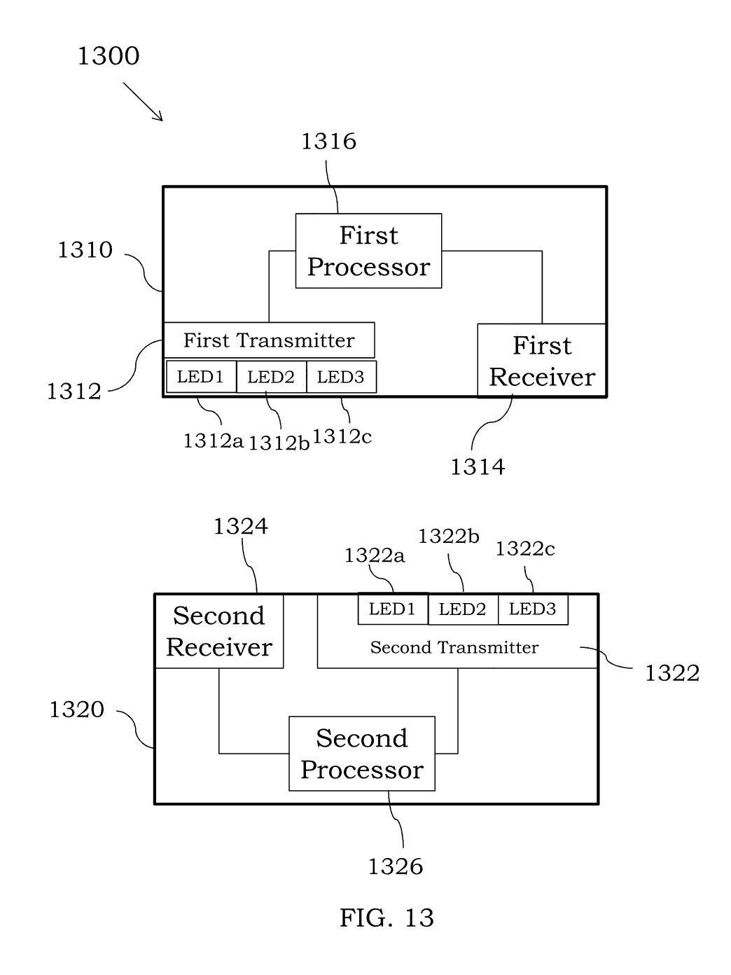

In some examples, each of a first OWC device and a second OWC device may comprise a transmitter comprising a plurality of narrow beam width light emitting diodes. Referring to FIG. 13, an OWC system 1300 is shown that comprises a first OWC device 1310 comprising a first transmitter 1312 and a first receiver 1314. A first processor 1316 is shown as being electrically coupled to each of the first transmitter 1312 and the first receiver 1314. The first OWC device 1310 can be coupled, e.g., in a wired or wireless manner, to an area network (not shown). For example, the first OWC device 1310 can be configured as a light fixture present within a building or other structure. The area network can be coupled to the light fixture in a wired manner, wireless manner, through a fiber optic cable, Ethernet cable, power line or other means. The first transmitter 1312 comprises a plurality of narrow beam width light emitting diodes 1312a, 1312b, and 1312c though fewer than three or more than three narrow beam width light emitting diodes may be present if desired. The LEDs 1312a-1312c may be the same or may be different. Each of the LEDs 1312a-1312c can be electrically coupled to the processor 1316 such that the processor 1316 can control which particular LED or LEDs provide an optical emission to a second receiver 1324 of a second OWC device 1320 to permit optical communication between the OWC device 1310 and the OWC device 1320. The second OWC device 1320 also comprises a second transmitter 1322 comprising a plurality of narrow beam width light emitting diodes 1322a, 1322b and 1322c though fewer than three or more than three narrow beam width light emitting diodes may be present if desired. The LEDs 1322a-1322c can be the same or can be different. The second transmitter 1322 and the second receiver 1324 are each electrically coupled to a second processor 1326. While not shown, the OWC device 1320 is typically coupled, e.g., in a wired or wireless manner, to an electronic device such as a wired router, a wireless router, a computer, a tablet, a mobile device or other electronic device. The OWC device 1320 can be coupled optically to an electronic device, e.g., through a fiber optic cable, as well if desired. Where the OWC device 1320 is coupled to an electronic device in a wired manner, the electronic device can couple to the OWC device 1320 through a USB interface, a micro-USB interface, a SATA interface, Ethernet interface, a Lightning port interface or other interfaces. Where the OWC device 1320 is coupled to an electronic device in a wireless manner, the electronic device can couple to the OWC device 1320 using Bluetooth, Wi-Fi, near field communication or other wireless communication protocols.

In certain configurations and as described herein, as a position of the OWC device 1320 is moved from a first position to a second position (different than the first position), the processors 1316 and 1326 can together be used to determine which particular LED of the LEDs 1212a-1212c should be used to provide an optical emission from the first OWC device 1310 to the second receiver 1324 of the second OWC device 1320. Where multiple independent optical emissions are occurring from the LEDs of the OWC devices 1310, 1320, the system can be configured to select which optical emission provides reliable optical communication between the devices 1310, 1320. For example, the OWC system 1300 can be configured to select one of the plurality of narrow beam width light emitting diodes 1312a-1312c of the first OWC device 1310 to provide a first optical emission from the first transmitter 1312 to the second receiver 1324 based on a first position of the second OWC device 1320 relative to a position of the first OWC device 1310. The OWC system 1300 can also be configured to select a different one of the plurality of narrow beam width light emitting diodes 1312a-1312c of the first OWC device 1310 to provide a second optical emission from the first transmitter 1312 to the second receiver 1324 based on a second position of the second OWC device 1320 relative to the position of the first OWC device 1310. As the position of the second OWC device 1320 changes, e.g., as a user moves about a room, the processors 1316 and 1326 can together determine which particular LED provides the best signal between the second OWC device 1320 and the first OWC device 1310. As a position of the OWC device 1320 is moved from a first position to a second position (different than the first position), the processors 1316 and 1326 can also together be used to determine which particular LED of the LEDs 1322a-1322c should be used to provide an optical emission from the second OWC device 1320 to the first OWC device 1310. For example, the OWC system 1300 can be configured to select one of the plurality of narrow beam width light emitting diodes 1322a-1322c of the second OWC device 1320 to provide a first optical emission from the second transmitter 1322 to the first receiver 1314 based on a first position of the second OWC device 1320 relative to a position of the first OWC device 1310. The OWC system 1300 can also be configured to select a different one of the plurality of narrow beam width light emitting diodes 1322a-1322c of the second OWC device 1320 to provide a second optical emission from the second transmitter 1322 to the first receiver 1314 based on a second position of the second OWC device 1320 relative to the position of the first OWC device 1310. As the position of the second OWC device 1320 changes, e.g., as a user moves about a room, the processors 1316 and 1326 can together determine which particular LED provides the best signal between the second OWC device 1320 and the first OWC device 1310. While not required, the first OWC device 1310 generally remains stationary within a building or other structure so the position of the first transmitter 1312 and first receiver 1314 generally do not change relative to the building or other structure.

While the LEDs shown in FIGS. 11-13 are described as being the same, any or more of the LEDs may comprise a beam cone, beam angle, beam shape, wavelength, etc. that is different from the other LEDs. In some examples, one of the LEDs of FIGS. 11-13 may be configured as a wide beam width LED and the other LEDs can be configured as narrow beam width LEDs. In other examples, one or more of the LEDs of FIGS. 11-13 may be configured as a laser diode.

In certain embodiments, the devices and systems described herein can be used in a method to provide information between a first optical wireless communication device and a second optical wireless communication device. For example, the method may comprise using a first processor, e.g., present in the first OWC device, to select one of a plurality of narrow beam width light emitting diodes of a second transmitter of the second OWC device to provide an optical emission to a first transmitter of the first OWC device based on a first position of the second OWC device. As the position of the second OWC device changes, the first processor can re-evaluate which particular LED may provide a better optical emission to the first OWC device to increase the overall reliability of the information transfer between the OWC devices. In some instances, an information packet can be provided, e.g., transmitted, from each of the plurality of narrow beam width light emitting diodes to the first receiver of the first OWC device to determine which of the plurality of narrow beam width light emitting diodes present on the second OWC device should be used to provide the optical emission. In other instances, the first processor is configured to determine which of the received information packets comprises the least amount of errors to generate a LED channel packet. The first processor can also be configured to provide the generated LED channel packet to a second receiver of the second optical wireless communication device. A second processor present in the second OWC device is electrically coupled to the second receiver and is configured to use the received, generated LED channel packet from the first OWC device to determine which of the plurality of narrow beam width light emitting diodes of the second OWC device should be used to provide the optical emission to the first OWC device. If desired, the system can be configured to periodically transmit the information packet over a first period from each of the plurality of narrow beam width light emitting diodes and use the first processor to determine which of the plurality of narrow beam width light emitting diodes should be used to provide the optical emission within the first period. For example, as a position of the second OWC changes within the first period, it may be desirable to use a different LED to provide the optical emission to the first OWC device.

In certain embodiments, each of the OWCs described herein can be electrically coupled to a processor which can be used to send and/or receive signals or information from one or more other components of the system. The sequence of events performed by each OWC can be performed automatically by the processor without the need for user intervention. For example, the processor can receive information, e.g., a data stream from a WAN, provide it to the transmitter of the first OWC device to provide an optical emission from a light emitting diode of the first OWC device to the receiver of the second OWC device. The processor can be integral to the OWC device, a network device or both or may be present on one or more interfaces or computers electrically coupled to the OWC devices. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Motorola PowerPC, Sun UltraSPARC, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, data values, etc. during operation of the OWC system. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system to encode the data stream and/or decode the data stream. Further, the processor can control the various NBWLEDs to select which particular NBWLED is used to provide an optical emission. The processor typically is electrically coupled to a power source which can, for example, be a direct current power source, an alternating current source or other power sources. The system may also include suitable circuitry, e.g., an LED drive circuit, to convert signals received from the various electrical devices present in the OWC systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the OWC devices may comprise a storage system that includes a memory chip and/or a computer readable and writeable nonvolatile recording medium in which codes of software can be stored that can be used by a program to be executed by the processor or information stored on or in the medium to be processed by the program. The medium may, for example, be a hard disk, solid state drive or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system.

In certain examples, the processor and an operating system may together define a platform for which application programs in high-level programming languages may be written. For example, software control of the various NBWLEDs of the transmitter can be implemented if desired. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit control or operation of the OWC systems remotely as desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. An optical wireless communication system configured to provide and receive information from an area network to an electronic device, the optical wireless communication system comprising:
a first optical wireless communication device configured to couple to the area network, the first optical wireless communication device comprising a first transmitter and a first receiver each electrically coupled to a first processor; and
a second optical wireless communication device configured to couple to the electronic device, wherein the second optical wireless communication device comprises a second transmitter and a second receiver each electrically coupled to a second processor, wherein the second transmitter comprises a plurality of narrow beam width light emitting diodes each electrically coupled to the second processor,
wherein the optical wireless communication system is configured to select one of the plurality of narrow beam width light emitting diodes of the second optical wireless communication device to provide a first optical emission from the second transmitter to the first receiver based on a first position of the second optical wireless communication device relative to a position of the first optical wireless communication device and is configured to select a different one of the plurality of narrow beam width light emitting diodes of the second optical wireless communication device to provide a second optical emission from the second transmitter to the first receiver based on a second position of the second optical wireless communication device relative to the position of the first optical wireless communication device.

2. The system of claim 1, wherein the electronic device coupled to the second optical wireless communication device is wirelessly coupled to the second optical wireless communication device.

3. The system of claim 2, wherein the electronic device wirelessly coupled to the second optical wireless communication device comprises a wireless router.

4. The system of claim 1, wherein the electronic device coupled to the second optical wireless communication device is coupled through a wired device to the optical wireless communication device.

5. The system of claim 4, wherein the electronic device coupled through the wired device comprises a USB interface, a micro-USB interface, a SATA interface, or a Lightning port interface.

6. The system of claim 1, wherein the first optical wireless communication device is configured as a light fixture and the area network is coupled to the light fixture wirelessly.

7. The system of claim 6, wherein the light fixture is coupled to the area network in a wired manner.

8. The system of claim 6, wherein the light fixture is coupled to the area network through a fiber optic cable.

9. The system of claim 6, wherein the light fixture is coupled to the area network through an Ethernet cable.

10. The system of claim 6, wherein the light fixture is coupled to the area network through a power line.

11. The system of claim 1, wherein the second transmitter of the second optical wireless communication device comprises at least three narrow beam width light emitting diodes each providing a beam cone, wherein the three narrow light beam light emitting diodes are positioned so a central axis of the beam cones diverge from each other.

12. The system of claim 1, wherein the second transmitter of the second optical wireless communication device comprises at least three narrow beam width light emitting diodes each providing a beam cone, wherein the three narrow light beam light emitting diodes are positioned so a central axis of the beam cones converge toward each other.

13. The system of claim 1, wherein the second transmitter of the second optical wireless communication device comprises at least three narrow beam width light emitting diodes each providing a beam cone, wherein the three narrow light beam light emitting diodes are positioned so the beam cones do not overlap in the first position of the second optical wireless communication device relative to the position of the first optical wireless communication device.

14. The system of claim 1, wherein the second transmitter of the second optical wireless communication device comprises at least three narrow beam width light emitting diodes each configured to provide an optical emission with a beam angle of 30 degrees or less.

15. The system of claim 14, wherein the second transmitter further comprises at least one wide beam width light emitting diode configured to provide an optical emission with a beam angle of 60 degrees or more.

16. The system of claim 1, wherein the second transmitter of the second optical wireless communication device comprises at least four narrow beam width light emitting diodes each configured to provide an optical emission with a beam angle of 30 degrees or less.

17. The system of claim 1, wherein the first transmitter of the first optical communication device comprises a plurality of narrow beam width light emitting diodes each electrically coupled to the first processor.

18. The system of claim 17, wherein the first transmitter of the first optical wireless communication device comprises at least three narrow beam width light emitting diodes each configured to provide an optical emission with a beam angle of 30 degrees or less.

19. The system of claim 18, wherein the first transmitter further comprises at least one wide beam width light emitting diode configured to provide an optical emission with a beam angle of 60 degrees or more.

20. The system of claim 1, wherein at least one of the plurality of light emitting diodes is configured as a laser diode.

21-51. (canceled)
